(19) United States
(12) Patent Application Publication
(10) Pub. No.: US 2018/0239345 A1
(43) Pub. Date: Aug. 23, 2018

(54) ABNORMALITY PREDICTOR DIAGNOSIS SYSTEM AND ABNORMALITY PREDICTOR DIAGNOSIS METHOD

(71) Applicant: HITACHI POWER SOLUTIONS CO., LTD., Ibaraki (JP)

(72) Inventor: Toujirou NODA, Ibaraki (JP)

(73) Assignee: HITACHI POWER SOLUTIONS CO., LTD., Ibaraki (JP)

(21) Appl. No.: 15/750,117

(22) PCT Filed: Aug. 3, 2016
(86) PCT No.: PCT/JP2016/072716

§ 371 Date: Feb. 2, 2018

(30) Foreign Application Priority Data
Aug. 5, 2015 (JP) 2015-155489

(51) Int. Cl. G05B 23/02

(52) U.S. Cl. CPC G05B 23/024; G05B 23/0283; G05B 23/0254

(57) ABSTRACT

An abnormality predictor diagnosis system includes: a sensor data acquisition that acquires sensor data; a learning identifies a detection value of a sensor when a predetermined time has passed since start of an operation process, identifies a value of a predetermined function when the predetermined time has passed since the start of the operation process using the predetermined function that outputs different values for respective times elapsed as time passes, and learns a normal model of the waveform based on the identified detection value and the value of the function; and a diagnosis means that, in a time-series waveform of sensor data as a diagnosis target, diagnoses the mechanical facility for presence of an abnormality predictor based on comparison of the detection value of the sensor and the value of the function when the predetermined time has passed since the start of the operation process, with the normal model.

### TECHNICAL FIELD

The present invention relates to an abnormality predictor diagnosis system and the like that diagnose a mechanical facility for the presence of an abnormality predictor.

### BACKGROUND ART

A technique is known that diagnoses a mechanical facility for the presence of an abnormality predictor based on detection values of a sensor and the like installed in the mechanical facility.

For instance, Patent Literature 1 describes an abnormality predictor diagnosis device that divides an operation schedule of a mechanical facility into multiple time slots, learns a cluster which indicates a normal range of the mechanical facility by clustering time-series data for each time slot, and diagnoses the mechanical facility for the presence of an abnormality predictor based on the cluster.

Also, Patent Literature 2 describes a plant monitoring device that obtains image data as learning data with 15-minute intervals, the image data indicating a temperature distribution of a plant to be monitored, learns a normal pattern of a temperature change using a neural network based on the learning data, and further identifies the presence or absence of abnormality of the plant to be monitored, based on the normal pattern.

### CITATION LIST

### Patent Literature

Patent Literature 1: Japanese Patent No. 5684941

Patent Literature 2: Japanese Unexamined Patent Application Publication No. H6-259678

### SUMMARY OF INVENTION

### Technical Problem

With the technique described in Patent Literature 1, clusters are collectively learned in each time slot included in the multiple time slots. Therefore, for instance, in one time slot, when time-series data has a rapidly varying waveform with a size in a predetermined range, or time-series data has a gently varying waveform with a size in the predetermined range, these are not distinguished, and diagnosis of “abnormal predictor is not present” may be made.

However, particularly, in a chemical plant and a pharmaceutical plant, importance is placed on also the waveform in addition to the size of time-series data. This is because the waveform of time-series data reflects the process of a chemical reaction and a reaction rate. When one of the two types (rapidly varying, gently varying) of waveforms indicates “abnormality predictor is not present”, the other type should be diagnosed as “abnormality predictor is present”. Therefore, the technique described in Patent Literature 1 has more room for improvement in diagnostic accuracy.

Also, with the technique described in Patent Literature 2, as described above, a normal pattern is learned based on the image data obtained with 15-minute intervals. However, the temperature distribution of a plant to be monitored varies every moment, and when the time-series waveform is attempted to be reflected in a normal pattern accurately, the amount of computation in a neural network becomes huge. Therefore, the technique described in Patent Literature 2 also has more room for improvement in diagnostic accuracy.

Thus, it is an object of the present invention to provide an abnormality predictor diagnosis system and the like capable of diagnosing a mechanical facility for the presence of an abnormality predictor with high accuracy.

### Solution to Problem

In order to solve the above-mentioned problem, an abnormality predictor diagnosis system according to the present invention includes: a sensor data acquisition means that acquires sensor data including a detection value of a sensor installed in a mechanical facility in which a predetermined operation process is repeated; a learning means that, in a time-series waveform of the sensor data in a period in which the mechanical facility is known to be normal, identifies the detection value of the sensor when a predetermined time has passed since start of the operation process, identifies a value of a predetermined function when the predetermined time has passed since the start of the operation process using the predetermined function that outputs different values for respective times elapsed from the start of the operation process, and learns a normal model of the waveform based on the identified detection value and the value of the function; and a diagnosis means that, in a time-series waveform of sensor data as a diagnosis target, diagnoses the mechanical facility for presence of an abnormality predictor based on comparison of the detection value of the sensor and the value of the function when the predetermined time has passed since the start of the operation process, with the normal model.

### Advantageous Effects of Invention

According to the present invention, it is possible to provide an abnormality predictor diagnosis system and the like that diagnose a mechanical facility for the presence of an abnormality predictor with high accuracy.

### BRIEF DESCRIPTION OF DRAWINGS

FIG. 1 is a configuration diagram of an abnormality predictor diagnosis system according to an embodiment of the present invention.

FIG. 2 is a waveform diagram illustrating a change in detection values of a sensor.

FIG. 3 is a configuration diagram of a data mining means included in the abnormality predictor diagnosis system.

FIG. 4 is an explanatory diagram related to detection values of a sensor, and the line expressed by a linear function.

FIG. 5 is an explanatory diagram of a cluster learned by a cluster learning unit.

FIG. 6 is a flowchart illustrating the processing of the abnormality predictor diagnosis system.

FIG. 7 is a flowchart of learning processing executed by a learning means.

FIG. 8 is a flowchart of diagnostic processing executed by a diagnosis means.

FIG. 9A is an explanatory diagram illustrating the waveform of learning target data, and the line of a linear function, and FIG. 9B is an explanatory diagram illustrating the waveform of diagnosis target data, and the line of a linear function at the time of occurrence of an abnormality predictor of a mechanical facility.

FIG. 10 is an explanatory diagram of clusters which are results of learning, and feature vectors of diagnosis target data.

FIG. 11A is an explanatory diagram illustrating another example of the waveform of learning target data, and the line of a linear function, and FIG. 11B is an explanatory diagram illustrating the waveform of diagnosis target data, and the line of a linear function at the time of occurrence of an abnormality predictor of a mechanical facility.

FIG. 12 is an explanatory diagram of clusters which are results of learning, and feature vectors of diagnosis target data.

### DESCRIPTION OF EMBODIMENTS

### Embodiment

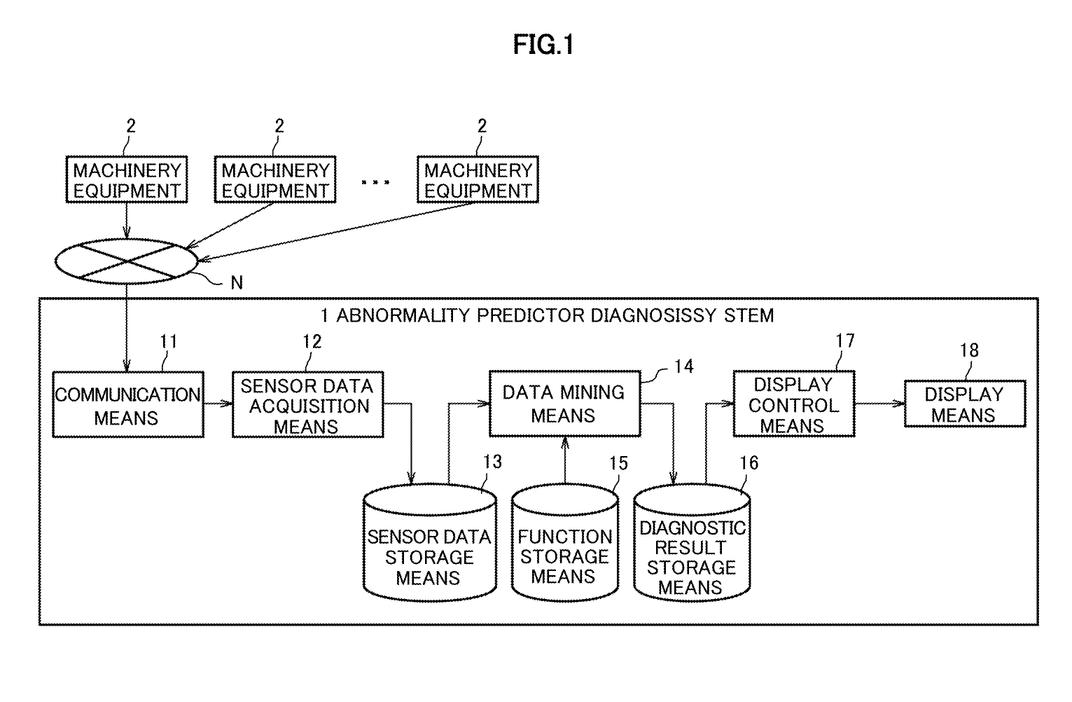

FIG. 1 is a configuration diagram of an abnormality predictor diagnosis system 1 according to this embodiment.

The abnormality predictor diagnosis system 1 is a system that diagnoses a mechanical facility 2 for the presence of an abnormality predictor based on sensor data including detection values of a sensor (not illustrated) installed in the mechanical facility 2. The above-mentioned “abnormality predictor” is a precursor to an occurrence of abnormality of the mechanical facility 2, and “abnormality predictor diagnosis” is to diagnose for the presence of an abnormality predictor.

Hereinafter the mechanical facility 2 will be briefly described before a description of the abnormality predictor diagnosis system 1 is given. The mechanical facility 2 is, for instance, a chemical plant, and includes a reactor, and a device (not illustrated) that loads chemical substances to the reactor. Then, a predetermined “operation process” is repeated in the mechanical facility 2, thus predetermined chemical substances are generated in each process. It is to be noted that the type of the mechanical facility 2 is not limited to this, and may be a pharmaceutical plant, a production line, a gas engine, a gas turbine, a power generation facility, a medical facility, or a communication facility.

In the mechanical facility 2, a sensor (not illustrated) which detects predetermined physical quantities (such as a temperature, a pressure, a flow rate, a current, a voltage) is installed. A physical quantity detected by the sensor is transmitted to the abnormality predictor diagnosis system 1 as sensor data via a network N. It is to be noted that in addition to a detection value of the sensor, and the date and time on which the physical quantity is detected, the sensor data also includes identification information of the mechanical facility 2, identification information of the sensor, and a signal indicating the start and end of an “operation process” which is repeated in the mechanical facility 2.

Hereinafter, as an example, the configuration of diagnosis of the mechanical facility 2 for the presence of an abnormality predictor based on the detection values of a sensor will be described, the sensor being one of multiple sensors installed in the mechanical facility 2 and sensitively reflecting an abnormality predictor of the mechanical facility 2.

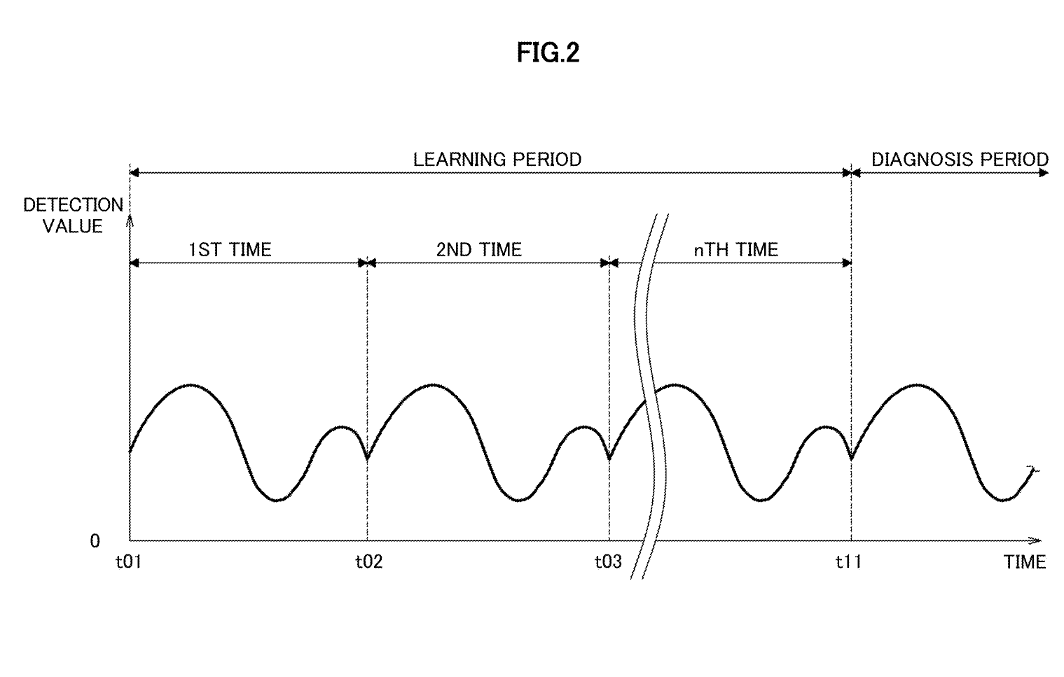

FIG. 2 is a waveform diagram illustrating a change in the detection values of the sensor. It is to be noted that the horizontal axis of FIG. 2 indicates time and the vertical axis indicates detection value of the sensor (not illustrated) installed in the mechanical facility 2.

In the example illustrated in FIG. 2, the 1st time operation process is executed in the mechanical facility 2 in the time slot from time t01 to time t02, and the 2nd time operation process is executed in the time slot from time t02 to time t03. Since a predetermined operation process is repeated in this manner, when the mechanical facility 2 is normal, the detection values of the sensor in the operation processes have a similar (that is, quite analogous) waveform.

In this embodiment, a time-series waveform (a waveform of each operation process) of sensor data is learned as a normal model based on the sensor data obtained in a predetermined learning period (see FIG. 2) in which the mechanical facility 2 is known to be normal, and the presence of an abnormality predictor of the mechanical facility 2 is determined based on the normal model. The details of the normal model will be described later.

### Configuration of Abnormality Predictor Diagnosis System

As illustrated in FIG. 1, the abnormality predictor diagnosis system 1 includes a communication means 11, a sensor data acquisition means 12, a sensor data storage means 13, a data mining means 14, a function storage means 15, a diagnostic result storage means 16, a display control means 17, and a display means 18.

The communication means 11 receives information including sensor data from the mechanical facility 2 via a network N. For instance, a router which receives information in accordance with a communication protocol of TCP/IP can be used as the communication means 11.

The sensor data acquisition means 12 acquires the sensor data included in the information received by the communication means 11 via the network N, and stores the acquired sensor data in the sensor data storage means 13.

The sensor data storage means 13 stores the sensor data acquired by the sensor data acquisition means 12, for instance, as a database. It is to be noted that a magnetic disk device, an optical disk device, a semiconductor memory device and the like may be used as the sensor data storage means 13.

The data mining means 14 learns a normal waveform of detection values (in other words, sensor data) of the sensor as a normal model by data mining that is a statistical data classification technique, and diagnoses the mechanical facility 2 for the presence of an abnormality predictor based on the normal model. The details of the data mining means 14 will be described later.

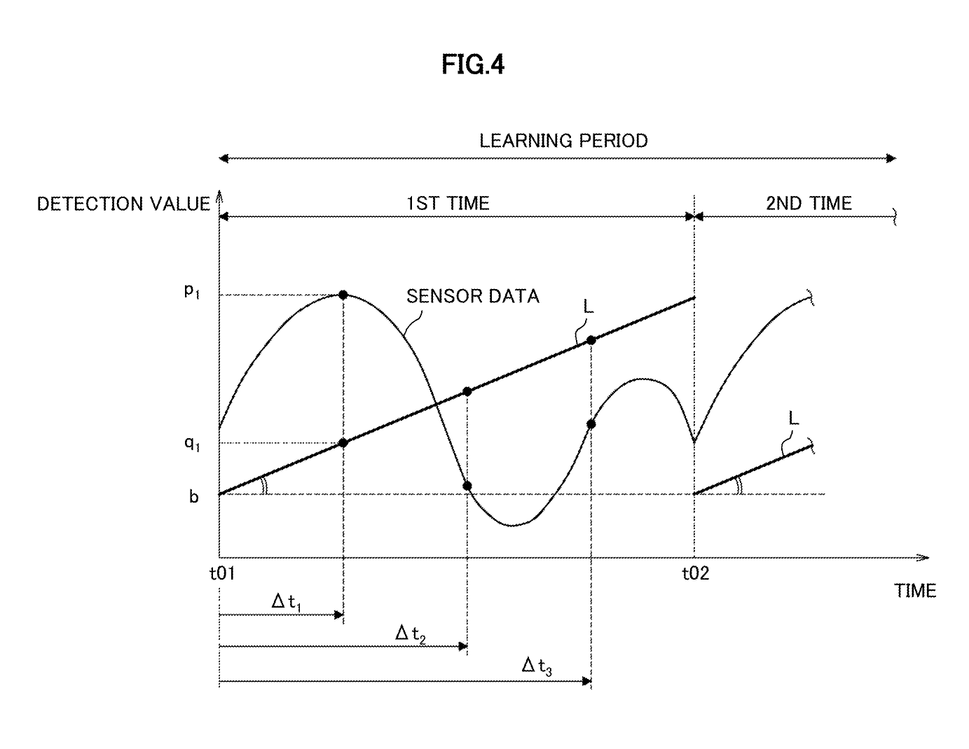

In the function storage means 15, linear functions (lines L illustrated in FIG. 4) which monotonously increase as time passes from the start times (times t01, t02, . . . illustrated in FIG. 4) of the operation processes are stored. The linear function is used by the data mining means 14.

In the diagnostic result storage means 16, a diagnostic result of the data mining means 14 is stored. The diagnostic result includes identification information of the mechanical facility 2, and the presence or absence of an abnormality predictor.

The display control means 17 outputs to the display means 18 a control signal for displaying the diagnostic result of the data mining means 14. For instance, the display control means 17 displays a diagnostic result on the display means 18 in a matrix format with a row indicating the name of each a mechanical facility 2 and a column indicating the date of diagnosis.

The display means 18 is, for instance, a liquid crystal display, and displays a diagnostic result in accordance with the control signal inputted from the display control means 17.

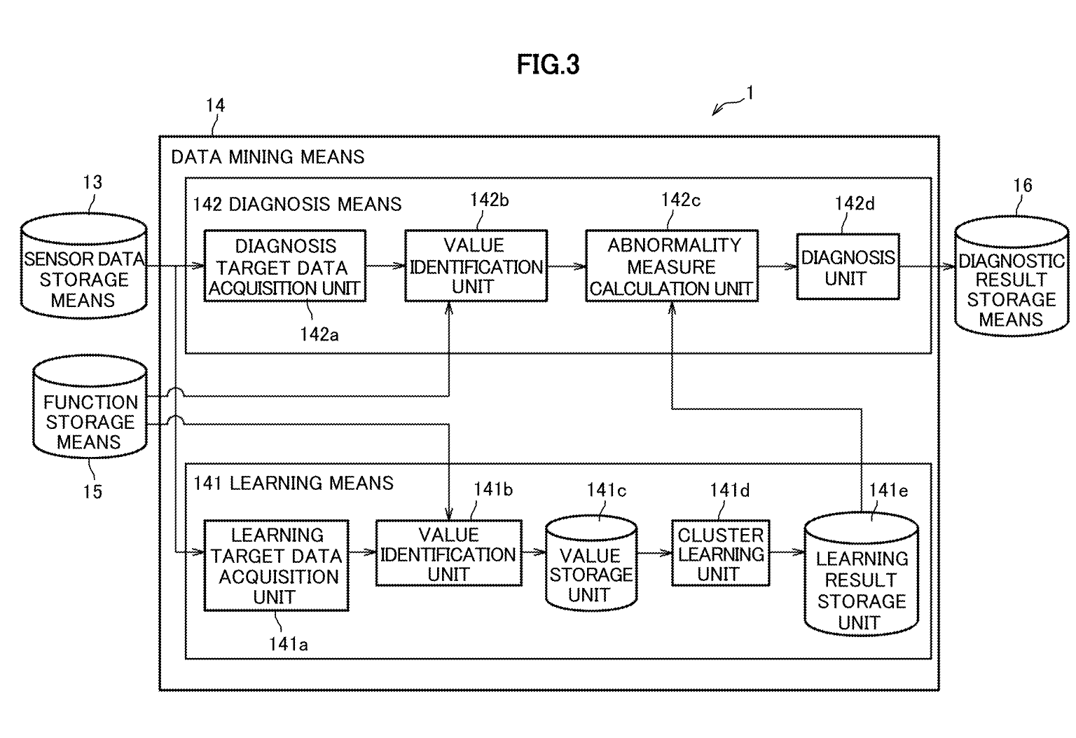

FIG. 3 is a configuration diagram of the data mining means 14 included in the abnormality predictor diagnosis system 1.

As illustrated in FIG. 3, the data mining means 14 includes a learning means 141 and a diagnosis means 142.

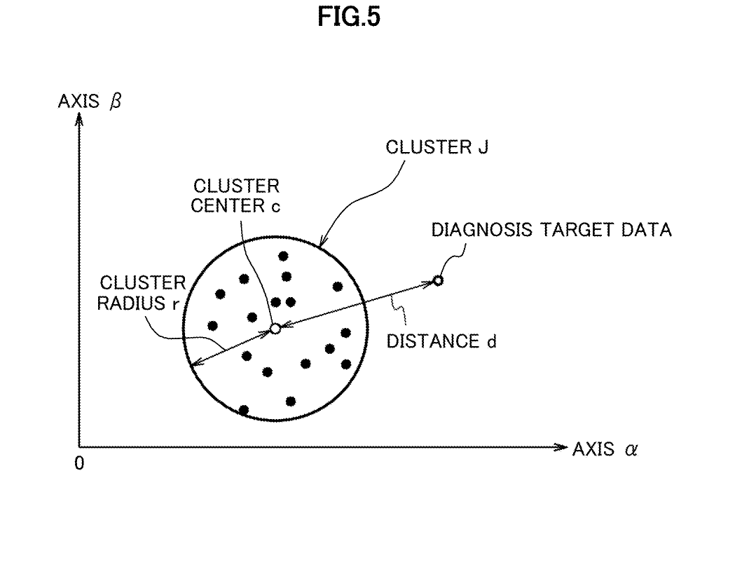

The learning means 141 learns a cluster (normal model) representing a normal waveform of detection values of a sensor by clustering that is one of the statistical data classification techniques. The cluster is an area identified by a cluster center c (see FIG. 5) and a cluster radius r (see FIG. 5) in a multi-dimensional vector space, and is learned based on the sensor data acquired in a predetermined learning period (see FIG. 2).

As illustrated in FIG. 3, the learning means 141 includes a learning target data acquisition unit 141a, a value identification unit 141b, a value storage unit 141c, a cluster learning unit 141d, and a learning result storage unit 141e.

The learning target data acquisition unit 141a acquires sensor data (that is, learning target data) which is a learning target from the sensor data storage means 13. Specifically, the learning target data acquisition unit 141a acquires sensor data for each operation process repeated in the mechanical facility 2, the sensor data being acquired in a predetermined learning period in which the mechanical facility 2 is known to be normal.

In the learning target data acquired by the learning target data acquisition unit 141a, the value identification unit 141b identifies the detection values of the sensor and the values of the linear function when the predetermined times Δt₁, Δt₂, Δt₃ (see FIG. 4) with different lengths have passed since the start of an operation process. The predetermined times Δt₁, Δt₂, Δt₃ are set beforehand so that an occurrence of an abnormality predictor of the mechanical facility 2 is sensitively reflected in the detection values of the sensor at the predetermined times Δt₁, Δt₂, Δt₃.

FIG. 4 is an explanatory diagram related to detection values of a sensor, and the line L expressed by a linear function.

As illustrated in FIG. 4, an operation process is repeated for the 1st time, the 2nd time, . . . in the mechanical facility 2, and accordingly, the detection value of the sensor varies. As described above, each line L illustrated in FIG. 4 is a linear function that monotonously increases as time passes from the start time (time t01, time t02, . . . ) of an operation process. The value identification unit 141b (see FIG. 3) identifies detection value p₁ (see FIG. 4) of the sensor and value q₁ (see FIG. 4) of the line L when the predetermined time Δt₁ has passed since the start of an operation process. Similarly, for other predetermined times Δt₂, Δt₃, the value identification unit 141b identifies each of the detection value of the sensor and the value of the linear function.

In the value storage unit 141c illustrated in FIG. 3, the detection values and values of the linear function identified by the value identification unit 141b are stored in association with the predetermined times Δt₁, Δt₂, Δt₃. It is to be noted that when an operation process is repeated n times in the learning period, (3×n) sets of a detection value and a value of the linear function are stored in the value storage unit 141c.

The cluster learning unit 141d learns a cluster (normal model) indicating a normal waveform of detection values of the sensor, based on the information stored in the value storage unit 141c.

FIG. 5 is an explanatory diagram of a cluster J learned by the cluster learning unit 141d. It is to be noted that the horizontal axis α of FIG. 5 is an axis indicating a numerical value after normalization of the value of the linear function, and the vertical axis β is an axis indicating a numerical value after normalization of the detection value of the sensor. The waveform of the sensor data for one-time operation process is expressed by the detection values of the sensor and the values of the linear function at the predetermined times Δt₁, Δt₂, Δt₃ (see FIG. 4). Specifically, the sensor data is represented by two-dimensional feature vectors having components obtained by performing normalization processing on the detection values of the sensor and the values of the linear function. Here, the “normalization processing” is processing that causes the detection values of the sensor and the values of the linear function to be dimensionless quantities allowing mutual comparison by dividing the values by representative values (such as an average value, a standard deviation).

Each of ● symbols (n symbols are present) illustrated in FIG. 5 indicates the sensor data when the predetermined time Δt₁, the predetermined time Δt₂, the predetermined time Δt₃ (see FIG. 4) have passed since the start of an operation process. It is to be noted that although one cluster J is illustrated in FIG. 5, actually, at least three clusters are generated corresponding to the predetermined times Δt₁, Δt₂, Δt₃.

The cluster learning unit 141d (see FIG. 3) classifies n feature vectors indicated by ● symbols into groups called clusters. Hereinafter, as an example, a case will be described where a cluster is learned by using k-means method which is non-hierarchical clustering. The cluster learning unit 141d first assigns a cluster to each feature vector at random, and calculates the center (the cluster center c, see FIG. 5) of each cluster based on the assigned data. The cluster center c is, for instance, the centroid of multiple feature vectors belonging to a cluster.

Subsequently, the cluster learning unit 141d determines the distance between a predetermined feature vector and each cluster center c, and reassigns the feature vector to a cluster with the shortest distance. The cluster learning unit 141d executes such processing on all feature vectors. When assignment of clusters is not changed, the cluster learning unit 141d completes cluster generation processing, or otherwise recalculates the cluster center c from a newly assigned cluster.

The cluster learning unit 141d then calculates the coordinate values of the cluster center c (see FIG. 5), and the cluster radius r (see FIG. 5) for each cluster. The cluster radius r is, for instance, the average value of the distances between the cluster center c and the feature vectors belonging to the cluster. The method of calculating the cluster radius r is not limited to this. For instance, a feature vector farthest from the cluster center c among the feature vectors belonging to the cluster is identified, and the distance between the feature vector and the cluster center c may be the cluster radius r. In this manner, the cluster learning unit 141d learns a cluster that represents a normal waveform of the sensor data.

In the learning result storage unit 141e illustrated in FIG. 3, the cluster information, which is the result of learning by the cluster learning unit 141d, is stored as a database. The cluster information includes the cluster center c, the cluster radius r, and identification information of the mechanical facility 2.

The diagnosis means 142 illustrated in FIG. 3 diagnoses the mechanical facility 2 for the presence of an abnormality predictor using the cluster learned by the learning means 141. The diagnosis means 142 includes a diagnosis target data acquisition unit 142a, a value identification unit 142b, an abnormality measure calculation unit 142c, and a diagnosis unit 142d.

The diagnosis target data acquisition unit 142a acquires the diagnosis target sensor data (that is, the diagnosis target data) from the sensor data storage means 13. That is, the diagnosis target data acquisition unit 142a acquires sensor data in the diagnosis period (see FIG. 2) after the learning period, for each operation process repeated in the mechanical facility 2.

In the diagnosis target data acquired by the diagnosis target data acquisition unit 142a, the value identification unit 142b identifies the detection values of the sensor and the values of the linear function when the predetermined times Δt₁, Δt₂, Δt_{'}have passed since the start of an operation process. The above-mentioned predetermined times Δt₁, Δt₂, Δt₃ are approximately the same as the predetermined times Δt₁, Δt₂, Δt₃ used by the learning means 141. In addition, the linear function (y=aΔt+b) used by the diagnosis means 142 is also approximately the same as the linear function (y=aΔt+b) used by the learning means 141.

The abnormality measure calculation unit 142c calculates an abnormality measure u of the diagnosis target data based on each detection value of the sensor and each value of the linear function identified by the value identification unit 142b, and the cluster information (the cluster center c, the cluster radius r) stored in the learning result storage unit 141e. First, the abnormality measure calculation unit 142c performs normalization processing on the detection value and the value of the linear function identified by the value identification unit 142b to convert into a two-dimensional feature vector. The abnormality measure calculation unit 142c refers to the cluster information stored in the learning result storage unit 141e, and identifies a cluster, among the clusters, having a cluster center c closest to the diagnosis target data. The abnormality measure calculation unit 142c then calculates an abnormality measure u based on the following (Expression 1) using the distance d (see FIG. 5) from the cluster center c of the identified cluster to the diagnosis target data, and the cluster radius r (see FIG. 5).

u=d/r (Expression 1)

The diagnosis unit 142d diagnoses the mechanical facility 2 for the presence of an abnormality predictor based on the abnormality measure u calculated by the abnormality measure calculation unit 142c. As an example, when the abnormality measure u<=1, the diagnosis target data is present in the cluster (that is, within the normal range), and thus the diagnosis unit 142d diagnoses the mechanical facility 2 as “abnormality predictor is not present”. On the other hand, when the abnormality measure u>1, the diagnosis target data is present outside the cluster (that is, outside the normal range), and thus the diagnosis unit 142d diagnoses the mechanical facility 2 as “abnormality predictor is present”. The diagnosis unit 142d stores a result of the diagnosis in the diagnostic result storage means 16 in association with the diagnosis target data.

For instance, when the number of pieces of diagnosis target data with an abnormality measure u exceeding a predetermined threshold value is greater than or equal to a predetermined number in the diagnosis period, the diagnosis unit 142d may diagnose the mechanical facility 2 as “abnormality predictor is present”.

### Operation of Abnormality Predictor Diagnosis System

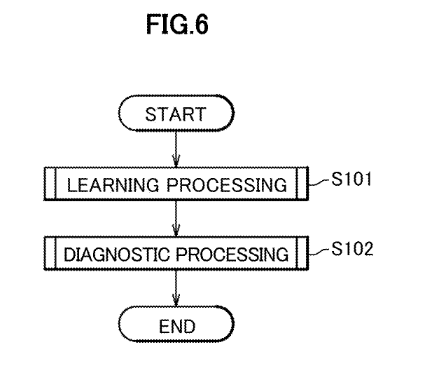

FIG. 6 is a flowchart illustrating the processing of the abnormality predictor diagnosis system 1. In step S101, the abnormality predictor diagnosis system 1 executes learning processing by the learning means 141 (see FIG. 3).

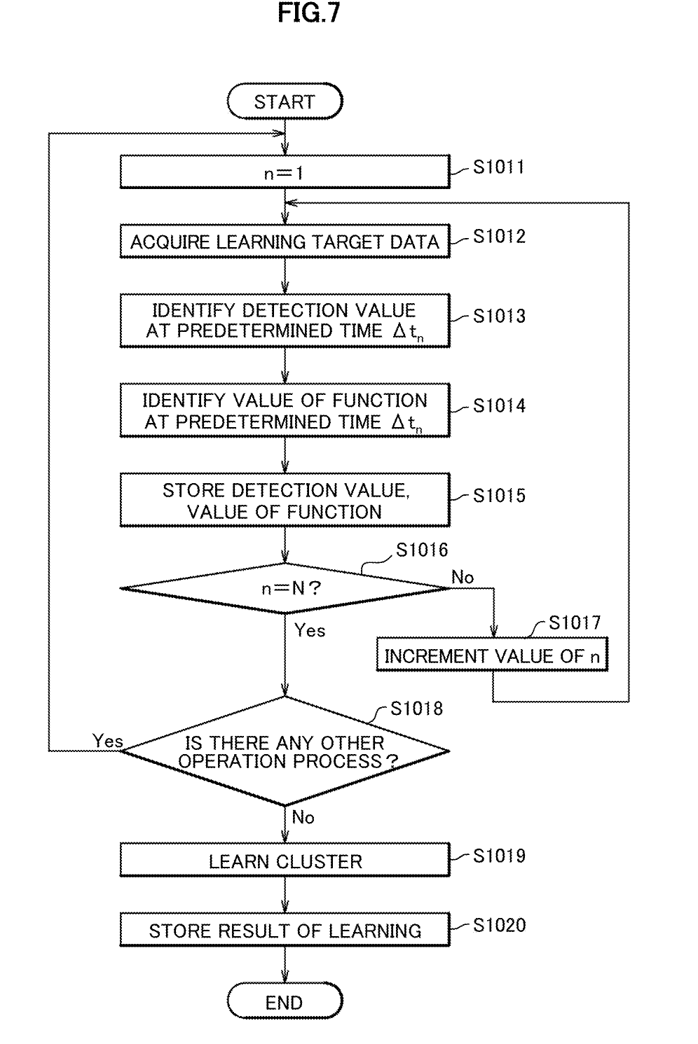

FIG. 7 is a flowchart of the learning processing executed by the learning means 141.

In step S1011, the learning means 141 sets value n to 1. The value n is a natural number that, when multiple predetermined times (3 predetermined times Δt₁, Δt₂, Δt₃ illustrated in FIG. 4) are present, is incremented (S1017) for selecting a predetermined time used for identifying the detection value of the sensor and the value of the linear function.

In step S1012, the learning means 141 acquires learning target data from the sensor data storage means 13 by the learning target data acquisition unit 141a. That is, the learning means 141 acquires sensor data in the 1st time operation process as the learning target out of the sensor data acquired in a learning period (see FIG. 2) in which the mechanical facility 2 is known to be in normal operation.

In step S1013, the learning means 141 identifies the detection value p₁ of the sensor when the predetermined time Δt₁ has passed since the start time (the time t01 illustrated in FIG. 4) of an operation process, by the value identification unit 141b. As described above, in addition to detection values of the sensor, the learning target data includes a signal indicating the start and end of an operation process. Therefore, the time t01 when the operation process is started can identified based on the signal.

In step S1014, the learning means 141 identifies the value q₁ of the linear function at the predetermined time Δt₁ by the value identification unit 141b (see FIG. 4). Specifically, the learning means 141 identifies value y (y=q₁ in FIG. 4) of the linear function by substituting the predetermined time Δt₁ into the linear function: y=aΔt+b.

In step S1015, the learning means 141 stores the detection value p₁ identified in step S1013, and the value q₁ of the linear function identified in step S1014 in the value storage unit 141c in association with the predetermined time Δt₁.

In step S1016, the learning means 141 determines whether or not the value n has reached a predetermined value N. The predetermined value N is the number of predetermined times Δtₙ (in this embodiment, 3 predetermined times Δt₁, Δt₂, Δt₃) used for identifying the detection value of the sensor and the value of the linear function.

When the value n has not reached the predetermined value N (No in S1016), in step S1017, the learning means 141 increments the value of n, and returns to the processing in step S1012. The learning means 141 then identifies the detection values of the sensor and the values of the linear function similarly for other predetermined times Δt₂, Δt₃ (see FIG. 4).

On the other hand, when the value n has reached the predetermined value N in step S1016 (Yes in S1016), the processing of the learning means 141 proceeds to step S1018.

In step S1018, the learning means 141 determines whether or not there is another operation process, for which a detection value of the sensor and a value of the linear function have not been acquired, in the learning period (see FIG. 2).

When there is another operation process in step S1018 (Yes in S1018), the processing of the learning means 141 returns to step S1011. In other words, for another operation process, the learning means 141 identifies the detection values and the values of the linear function when the predetermined times Δt₁, Δt₂, Δt₃ have passed since the start of the operation process. For instance, since the 2nd time operation process is started from the time t02 illustrated in FIG. 4, the detection values of the sensor and the values of the linear function when the predetermined times Δt₁, Δt₂, Δt₃ have passed since the time t02 are identified.

On the other hand, where there is no other operation process, for which a detection value of the sensor and a value of the linear function have not been acquired in step S1018 (No in S1018), the processing of the learning means 141 proceeds to step S1019.

In step S1019, the learning means 141 learns a cluster based on the data stored in the value storage unit 141c. That is, as described above, the learning means 141 converts each detection value of the sensor and each value of the linear function into a two-dimensional feature vector, and learns a cluster (normal model) that represents a normal waveform of the detection value of the sensor by clustering each feature vector.

In step S1020, the learning means 141 stores the result learned in step S1019 in the learning result storage unit 141e, and completes a series of learning processing (END).

After the learning processing in step S101 illustrated in FIG. 6 is performed, in step S102, the abnormality predictor diagnosis system 1 executes diagnostic processing by the diagnosis means 142 (see FIG. 3).

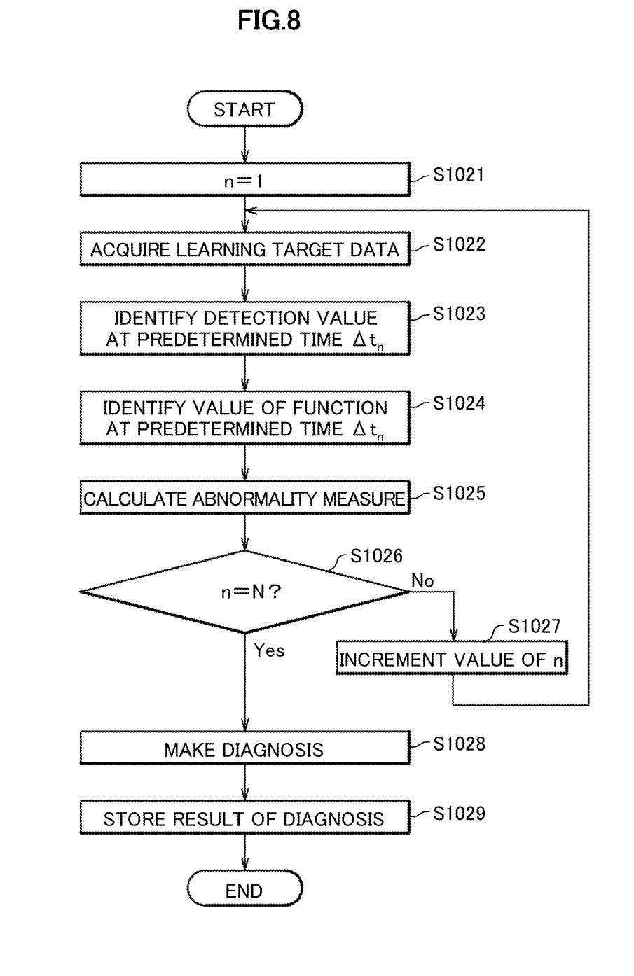

FIG. 8 is a flowchart of the diagnostic processing executed by the diagnosis means 142.

In step S1021, the diagnosis means 142 sets the value n to 1. The value n is the same as the value n described in step S1011 of FIG. 7.

In step S1022, the diagnosis means 142 acquires the diagnosis target data from the sensor data storage means 13 by the diagnosis target data acquisition unit 142a. That is, the diagnosis means 142 acquires the sensor data of the 1st time operation process as a diagnosis target out of the sensor data acquired in the diagnosis period (see FIG. 2) after the learning period.

In step S1023, the diagnosis means 142 identifies the detection value of the sensor when the predetermined time Δt₁ has passed since the start time of an operation process by the value identification unit 142b.

In step S1024, the diagnosis means 142 substitutes the predetermined time Δt₁ into the linear function by the value identification unit 142b to identify the value of the linear function.

In step S1025, the diagnosis means 142 calculates the abnormality measure u of the diagnosis target data by the abnormality measure calculation unit 142c. That is, in step S1025, the diagnosis means 142 normalizes the detection value identified in step S1023 and the value of the linear function identified in step S1024 to generate a two-dimensional feature vector having the normalized values as the components. The diagnosis means 142 then calculates the abnormality measure u of the diagnosis target data using the (Expression 1) based on the feature vector and the cluster information stored in the learning result storage unit 141e.

In step S1026, the diagnosis means 142 determines whether or not the value n has reached a predetermined value N. The predetermined value N is the number of predetermined times Δtₙ (3 in this embodiment), and is the same as the predetermined value N (see FIG. 7) used in the learning processing. When the value n has not reached the predetermined value N (No in S1026), in step S1027, the diagnosis means 142 increments the value of n, and returns to the processing in step S1022.

On the other hand, when the value n has reached the predetermined value N in step S1026 (Yes in S1026), the processing of the diagnosis means 142 proceeds to step S1028.

In step S1028, the diagnosis means 142 diagnoses the mechanical facility 2 for the presence of an abnormality predictor by the diagnosis unit 142d. Specifically, the diagnosis means 142 diagnoses the mechanical facility 2 for the presence of an abnormality predictor based on the abnormality measure u calculated in step S1025.

In step S1029, the diagnosis means 142 stores a diagnostic result in the diagnostic result storage means 16, and completes a series of diagnostic processing (END). The diagnosis means 142 repeats such diagnostic processing for each operation process included in the diagnosis period (see FIG. 2).

It is to be noted that the information stored in the diagnostic result storage means 16 is displayed on the display means 18 (see FIG. 1) by the display control means 17 (see FIG. 1).

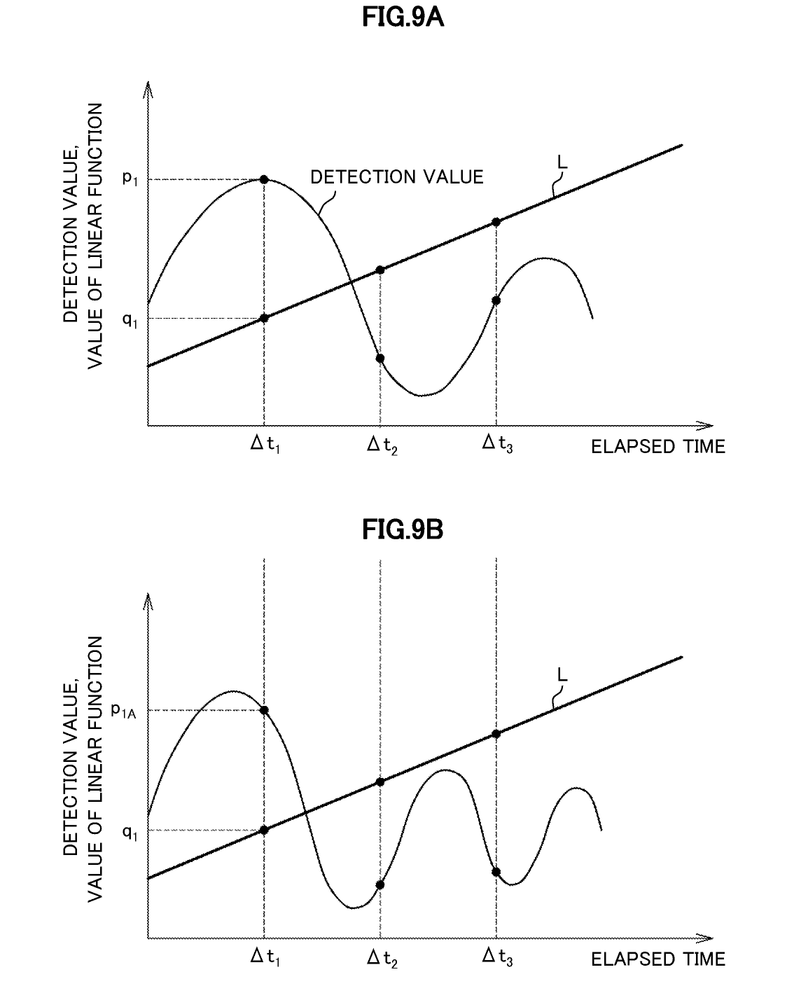

FIG. 9A is an explanatory diagram illustrating the waveform of learning target data, and line L of a linear function.

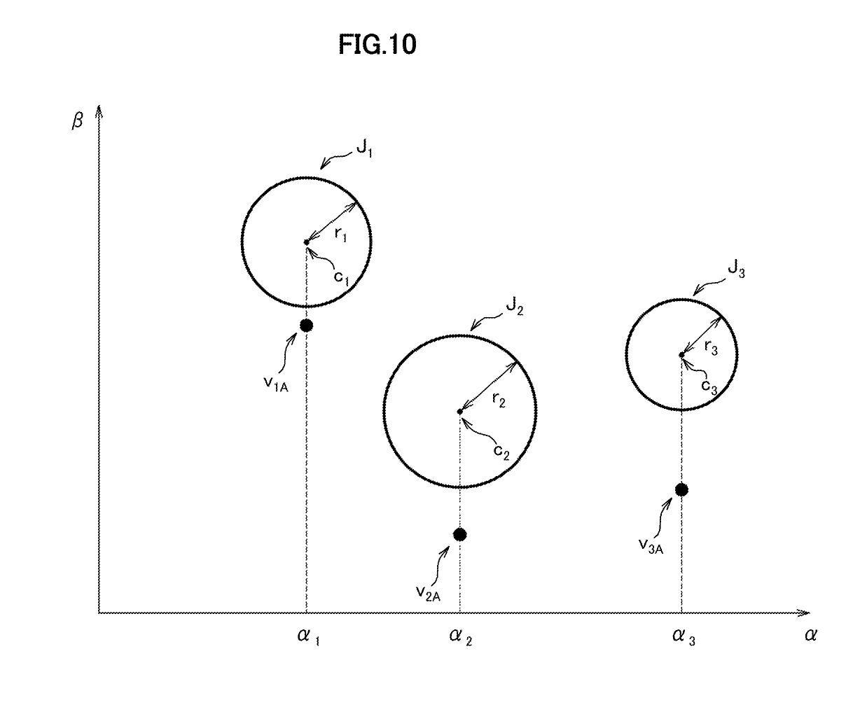

The waveform of the detection values illustrated in FIG. 9A is the learning target data (detection values) acquired in one-time operation process included in the learning period. As described above, a two-dimensional feature vector is generated, which has component values obtained by normalizing the detection value p₁ of the sensor and the value q₁ of the linear function (the line L) when the predetermined time Δt₁ has passed since the start of an operation process. Also, feature vectors are generated for other predetermined times Δt₂, Δt₃, and feature vectors are also generated for other operation processes included in the learning period. The clusters J₁, J₂, J₃ (see FIG. 10) described subsequently are learned based on those feature vectors.

FIG. 10 is an explanatory diagram of the clusters J₁, J₂, J₃ which are results of learning, and the feature vectors v_{1A}, v_{2A}, v_{3A} of diagnosis target data. The horizontal axis α of FIG. 10 indicates a numerical value after normalization of the value of the linear function, and the vertical axis β indicates a numerical value after normalization of the detection value of the sensor. The cluster J₁ illustrated in FIG. 10 is the cluster based on the detection value of the sensor and the value of the linear function when the predetermined time Δt₁ (see FIG. 9A) has passed since the start time of an operation process, and the cluster is represented by the cluster center c₁ and the cluster radius r₁. Similarly, the cluster J₂ is the cluster corresponding to the predetermined time Δt₂ (see FIG. 9A), and the cluster J₃ is the cluster corresponding to the predetermined time Δt₃ (see FIG. 9A). Incidentally, multiple clusters may be learned at a predetermined time Δtₙ.

FIG. 9B is an explanatory diagram illustrating the waveform of diagnosis target data, and line L of a linear function at the time of occurrence of an abnormality predictor of the mechanical facility 2.

In the example illustrated in FIG. 9B, the maximum value and the minimum value of the detection value in one-time operation process are the same as in the learning target data (see FIG. 9A) when the mechanical facility 2 is in normal operation, however, the waveform is different from that in a normal time. In a conventional abnormality predictor diagnosis system, diagnosis is made for the presence of an abnormality predictor based on only the detection values of a sensor, and thus erroneous diagnosis may be made as “abnormality predictor is not present” based on the diagnosis target data illustrated in FIG. 9B.

In contrast, in this embodiment, the mechanical facility 2 is diagnosed for the presence of an abnormality predictor based on whether or not a feature vector is present in a cluster, the feature vector being identified by the detection values of the sensor and the values of the linear function when the predetermined times Δt₁, Δt₂, Δt₃ have passed since the start time of an operation process. For instance, a feature vector v_{1A} indicated by ● symbol of FIG. 10 is generated based on the detection value p_{1A} and the value q₁ (value α₁ after normalization, see FIG. 10) of the linear function at the predetermined time Δt₁ illustrated in FIG. 9B. The feature vector v_{1A} is not included in the cluster J₁ closest to the feature vector v_{1A}, and thus diagnosed as “abnormality predictor is present” by the diagnosis unit 142d. The same goes for a feature vector v_{2A} corresponding to the detection value and the like of the predetermined time Δt₂ (see FIG. 9B), and a feature vector v_{3A} corresponding to the detection value and the like of the predetermined time Δt₃ (see FIG. 9B).

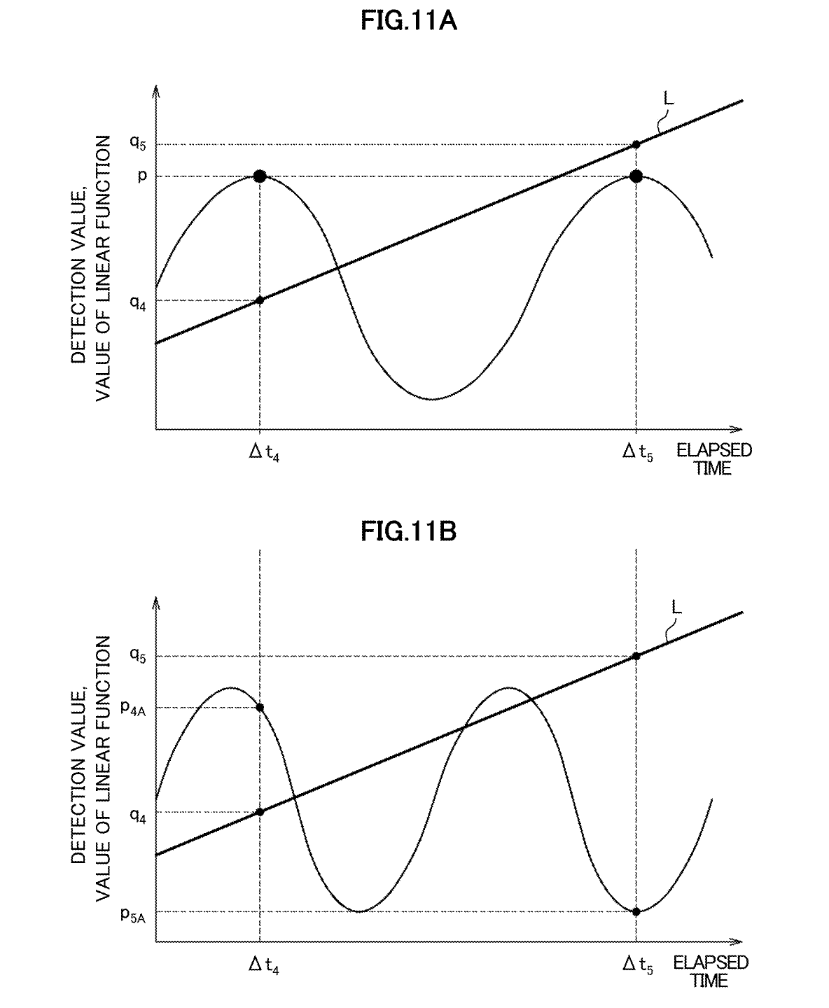

FIG. 11A is an explanatory diagram illustrating another example of the waveform of learning target data, and line L of a linear function.

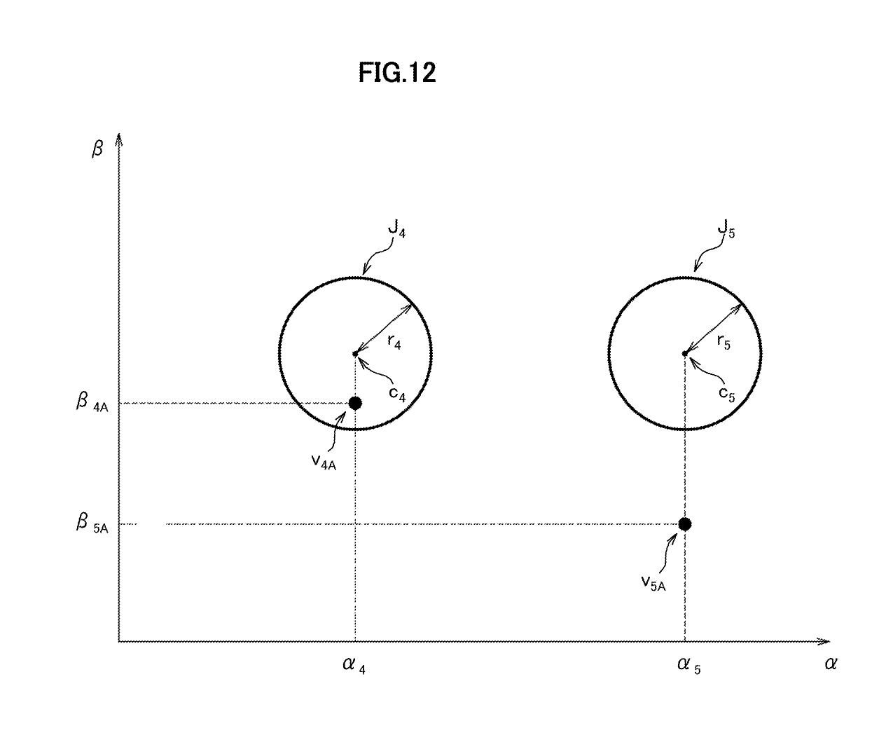

In the example illustrated in FIG. 11A, the detection value of a sensor varies in a sine wave form in the learning period in which the mechanical facility 2 is in normal operation. Also, two predetermined times Δt₄, Δt₅, which provide local maximum points of the waveform of detection values, are set. A cluster (normal model) that represents a normal waveform of the detection values is learned based on the detection values of the sensor and the values of the linear function when the predetermined times Δt₄, Δt₅ have passed since the start time of an operation process. As illustrated in FIG. 11A, the detection values p at the predetermined times Δt₄, Δt₅ are the same, however, the values q₄, q₅ of the linear function are significantly different (q₄<q₅). As a result, different clusters J₄, J₅ (see FIG. 12) corresponding to the predetermined times Δt₄, Δt₅ are learned.

Incidentally, in a conventional technique that learns a cluster based on only the detection values of the sensor, the detection value p at the predetermined time Δt₄ and the detection value p at the predetermined time Δt₅ have not been distinguished in the learning processing. In contrast, in this embodiment, even when the same value p is detected, if the predetermined times Δt₄, Δt₅ are different, clusters can be learned in a distinguished manner. The learning result contributes to higher accuracy of abnormality predictor diagnosis as described later.

FIG. 11B is an explanatory diagram illustrating the waveform of diagnosis target data, and line L of a linear function at the time of occurrence of an abnormality predictor.

In the example illustrated in FIG. 11B, although the amplitude and the maximum value, the minimum value of the waveform of the diagnosis target data are the same as in a normal time, the period of the waveform is shorter than in a normal time. As a result, particularly the detection value p_{5A} at the predetermined time Δt₅ is significantly smaller than the detection value p in a normal time.

FIG. 12 is an explanatory diagram of clusters J₄, J₅ which are results of learning, and feature vectors v_{4A}, v_{5A} of diagnosis target data. It is to be noted that the horizontal axis α and the vertical axis β are the same as in FIG. 10.

The cluster J₄ illustrated in FIG. 12 is the cluster that is learned by using the detection value of the sensor, and the value of the linear function when the predetermined time Δt₄ (see FIG. 11A) has passed since the start time of an operation process. The cluster J₅ is the cluster based on the detection value of the sensor, and the value of the linear function when the predetermined time Δt₅ (see FIG. 11A) has passed since the start time of an operation process.

As described above, the detection value p_{5A} (see FIG. 11B, value β_{5A} after normalization illustrated: see FIG. 12) at the predetermined time Δt₅ is significantly smaller than the detection value p in a normal time. Therefore, the feature vector v_{5A} identified by the detection value and the value of the linear function at the predetermined time Δt₅ is located outside the cluster J₅ in the nearest neighbor. As a result, the feature vector v_{5A} is diagnosed as “abnormality predictor is present” by the diagnosis unit 142d.

It is to be noted that since the values q₄, q₅ (see FIG. 11A) of the linear function at the predetermined times Δt₄, Δt₅ are different in magnitude, the clusters J₄, J₅ illustrated in FIG. 12 are relatively separated in α axis direction. Also, in the feature vector v_{5A} (see FIG. 12) which is the diagnosis target data, value α₅ in the α axis direction is approximately equal to α component of the cluster center c₅. This is because even for the learning target data or the diagnosis target data, the same value q₅ of the linear function at the predetermined time Δt₅ is provided (see FIGS. 11A and 11B). As a result, the cluster with a cluster center closest to the feature vector v_{5A} is the cluster J₅ and not the cluster J₄. Therefore, the abnormality measure u of the detection value p_{5A} at the predetermined time Δt₅ can be calculated based on the cluster J₅ corresponding to the predetermined time Δt₅. Consequently, it is possible to diagnose whether or not the waveform of the detection values of the diagnosis target data is abnormal with high accuracy (in other words, the presence of an abnormality predictor of the mechanical facility 2).

### Effects

According to this embodiment, the detection values and the values of the monotonously increasing linear function when the predetermined times Δtₙ has passed since the start time of an operation process are converted to a two-dimensional feature vector, and a normal waveform of the detection values of the sensor can be learned as a cluster based on the feature vector.

Also, for the diagnosis target data, a feature vector is similarly generated, and it is possible to diagnose whether or not the waveform is abnormal with high accuracy based on the cluster which is a result of the learning (in other words, whether or not an abnormality predictor has occurred in the mechanical facility 2).

### Modifications

Although the abnormality predictor diagnosis system 1 according to the present invention has been described based on the embodiments above, the present invention is not limited to these embodiments, and various modifications may be made.

Although in the embodiment, a case has been described where two or three predetermined times Δtₙ (see FIGS. 9A and 9B, FIGS. 11A and 11B) are set in order to identify the detection value and the value of the linear function, the invention is not limited to this. Specifically, the number of predetermined times Δtₙ may be one, or may be four or greater.

Although in the embodiment, a case has been described where a linear function that monotonously increases as time passes is used, the invention is not limited to this. For instance, a linear function that monotonously decreases as time passes may be used, or a curved function that monotonously increases or monotonously decreases as time passes may be used. In more general, a predetermined function, which outputs a different value as time passes, may be used.

Although a case has been described where a two-dimensional feature vector based on a detection value of a sensor, and a value of a linear function is individually determined for each of the predetermined times Δt₁, Δt₂, Δt₃, the invention is not limited to this. Specifically, in the time-series waveform of sensor data which is a learning target, the waveform data including the detection values of the sensor and the values of the linear function at the predetermined times Δt₁, Δt₂, Δt₃ are converted to a 6-dimensional feature vector by the learning means 141, and a cluster may be learned based on the feature vector obtained for each operation process. In the time-series waveform of sensor data which is a diagnosis target, the waveform data including the detection values of the sensor and the values of the linear function at the predetermined times Δt₁, Δt₂, Δt₃ are obtained by the diagnosis means 142, and the mechanical facility 2 may be diagnosed for the presence of an abnormality predictor based on the comparison between the waveform data and a normal model. It is to be noted that the method and the like of calculating an abnormality measure u are the same as in the embodiment. Consequently, the waveform of the detection values of the sensor in one-time operation process can be expressed by a 6-dimensional feature vector, and thus an abnormality (in other words, an abnormality predictor in the mechanical facility 2) of the waveform can be diagnosed with high accuracy.

Although in the embodiment, a case has been described, where the mechanical facility 2 is diagnosed for the presence of an abnormality predictor based on the sensor data acquired from one sensor, the invention is not limited to this. Specifically, the mechanical facility 2 may be diagnosed for the presence of an abnormality predictor based on the sensor data acquired from multiple sensors. In this case, as described in the embodiment a multi-dimensional feature vector may be generated based on the detection values of the sensors and the values of the linear function when the predetermined times have passed since the start time of an operation process. It is to be noted that the dimension number of the feature vector is (the number of sensors)+1. A user can recognize what type of abnormality has occurred at which position of the mechanical facility 2 by using multiple sensors in this manner.

Although in the embodiment, a case has been described where an operation process of the mechanical facility 2 is repeated without a break, the invention is not limited to this. That is, it is sufficient that the start and end of each operation process of the mechanical facility 2 be recognized, and an operation process may be performed with a predetermined break period.

Although in the embodiment, the configuration has been described, in which a learned cluster is subsequently held (stored), the invention is not limited to this. Specifically, sensor data which is diagnosed as “abnormality predictor is not present” by the diagnosis unit 142d may be added to the learning target data, and the cluster center c and the cluster radius r may be recalculated (in other words, a cluster is re-learned) based on the learning target data with the addition. A cluster is re-learned in this manner, and thus information on the normal state of the mechanical facility 2 is gradually increased, and the cluster center c and the cluster radius r can be updated to more appropriate values.

As described above, each time learning target data is added, the oldest data in the existing learning target data may be excluded from the learning target. Thus, even when the mechanical facility 2 changes over time according to seasonal change, the cluster can be updated to follow the change, and eventually, the diagnostic accuracy for an abnormality predictor can be increased.

It is to be noted that the present invention is not limited to the embodiments including all the components described in each embodiment. Also, part of the components of an embodiment may be replaced by a component of another embodiment, and a component of another embodiment may be added to the components of an embodiment. Also, another component may be added to, deleted from, or may replace part of the components of each embodiment.

Also, part or all of the components illustrated in FIG. 1, FIG. 3 may be implemented by hardware, for instance, by designing an integrated circuit. Each component described above may be implemented by software in which a processor interprets and executes a program that implements each function. Information, such as a program, a tape, a file, which implements each function may be stored in a recording device, such as a memory, a hard disk, an SSD (Solid State Drive) or a recording medium, such as an IC card, an SD card, a DVD. Also, a control line or an information line which is considered to be necessary for description is illustrated, and all the control lines or information lines are not necessarily illustrated for a product. It may be interpreted that almost all components are practically connected to each other.

### REFERENCE SIGNS LIST

1 abnormality predictor diagnosis system
2 mechanical facility
11 communication means
12 sensor data acquisition means
13 sensor data storage means
14 data mining means
15 function storage means
16 diagnostic result storage means
17 display control means
18 display means
141 learning means
141a learning target data acquisition unit
141b value identification unit
141c value storage unit
141d cluster learning unit
141e learning result storage unit
142 diagnosis means
142a diagnosis target data acquisition unit
142b value identification unit
142c abnormality measure calculation unit
142d diagnosis unit

1. An abnormality predictor diagnosis system comprising:
a sensor data acquisition means that acquires sensor data including a detection value of a sensor installed in a mechanical facility in which a predetermined operation process is repeated;
a learning means that, in a time-series waveform of the sensor data in a period in which the mechanical facility is known to be normal, identifies the detection value of the sensor when a predetermined time has passed since start of the operation process, identifies a value of a predetermined function when the predetermined time has passed since the start of the operation process using the predetermined function that outputs different values for respective times elapsed from the start of the operation process, and learns a normal model of the waveform based on the identified detection value and the value of the function; and
a diagnosis means that, in a time-series waveform of sensor data as a diagnosis target, diagnoses the mechanical facility for presence of an abnormality predictor based on comparison of the detection value of the sensor and the value of the function when the predetermined time has passed since the start of the operation process, with the normal model.

2. The abnormality predictor diagnosis system according to claim 1, wherein the predetermined function is a function that monotonously increases or monotonously decreases.

3. The abnormality predictor diagnosis system according to claim 1, wherein in a time-series waveform of sensor data as a learning target, the learning means learns the normal model based on waveform data including the detection value and the value of the function in each of a plurality of predetermined times having different lengths from the start of the operation process, the each of the plurality of predetermined times being the predetermined time, and
in the time-series waveform of sensor data as the diagnosis target, the diagnosis means acquires the waveform data including the detection value and the value of the function in each of the plurality of predetermined times having different lengths from the start of the operation process, and diagnoses the mechanical facility for presence of an abnormality predictor based on comparison between the waveform data and the normal model.

4. The abnormality predictor diagnosis system according to claim 1, wherein the learning means learns at least one cluster, represented by a cluster center and a cluster radius, as the normal model by clustering a feature vector having components which are obtained by performing normalization processing on the identified detection value and the value of the function for producing dimensionless quantities which allow mutual comparison, and
the diagnosis means performs normalization processing on the sensor data as the diagnosis target to convert to a feature vector, identifies a cluster with the cluster center closest to the feature vector among the at least one cluster, calculates a ratio of a distance between the cluster center of the cluster and the feature vector to the cluster radius as an abnormality measure, and diagnoses the mechanical facility for presence of an abnormality predictor based on the abnormality measure.

5. The abnormality predictor diagnosis system according to claim 1, wherein the learning means adds sensor data, which is diagnosed by the diagnosis means as having no abnormality predictor, to the learning target, and re-learns the normal model including the added sensor data.

6. A method of diagnosing an abnormality predictor, the method comprising:
acquiring sensor data including a detection value of a sensor installed in a mechanical facility in which a predetermined operation process is repeated;
in a time-series waveform of the sensor data in a period in which the mechanical facility is known to be normal, identifying the detection value of the sensor when a predetermined time has passed since start of the operation process, identifying a value of a predetermined function when the predetermined time has passed since the start of the operation process using the predetermined function that outputs different values for respective times elapsed from the start of the operation process, and learning a normal model of the waveform based on the identified detection value and the identified value of the function; and
in a time-series waveform of sensor data as a diagnosis target, diagnosing the mechanical facility for presence of an abnormality predictor based on comparison of the detection value of the sensor and the value of the function when the predetermined time has passed since the start of the operation process, with the normal model.
